(19) United States
(12) Patent Application Publication
(10) Pub. No.: US 2002/0067235 A1
(43) Pub. Date: Jun. 6, 2002

(54) High Q spiral inductor

(75) Inventors: Kazuhiko Ueda, Fukushima-ken (JP); Masami Miyazaki, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 10/037,104

(22) Filed: Oct. 22, 2001

(30) Foreign Application Priority Data
Oct. 23, 2000 (JP) 2000-328406

(51) Int. Cl. H01F 5/00

(52) U.S. Cl. 336/200; 336/212

(57) ABSTRACT

A spiral inductor according to the present invention is formed in the following manner. While the spacing between adjacent spiral turns of a conductor is the same, the width of an inner portion of the conductor is smaller than the width of an outer portion of the conductor. Thus, the inner portion of the conductor is spaced away from the center, and hence magnetic lines of force have a reduced effect on opposed portions of the conductor. Thus, the inductance becomes large, and the spiral inductor has a higher Q as compared with that of a conventional spiral inductor.

### BACKGROUND OF THE INVENTION

1. Field of the Invention

The present invention relates to spiral inductors suitable for use in transmitter-receiver units in cellular phones that operate in a radio-frequency band.

2. Description of the Related Art

FIG. 2 illustrates the structure of a conventional spiral inductor. An insulating substrate 21 is formed on a printed wiring board. A spiral inductor 23, comprised of a conductor 22 having a conductive pattern, is fabricated on a surface of the insulating substrate 21.

The width of the conductor 22 that forms the inductor 23 is constant from the outer side to the inner side of the spiral. The spacing between adjacent spiral turns of the conductor 22 is the same throughout the entire conductor 22.

A first end at the outer side and a second end at the inner side form terminal areas 22a and 22b, respectively. An electrical current A flows from the terminal area 22a in the direction indicated by arrows A1, A2, A3, and A4, and is led out from the terminal area 22b.

The conventional spiral inductor 23 shown in FIG. 2 is formed by the conductor 22 having a width of 75 μm, and is wound using three turns at a spacing of 25 μm.

Referring to FIG. 3, a dotted line K2 indicates measured inductance values L (nH) for the conventional inductor 23. As is clear from FIG. 3, the inductance L is small, i.e., 5 to 7 nH, at frequencies of 1.5 GHz to 4.0 GHz.

A factor causing the small inductance L is described as follows. Specifically, when the current A flows through the spiral inductor 23, the current A flows through opposed portions of the conductor 22, with respect to the center 02 of the inductor 23, at the opposite sides (the arrows A1 and A3, and the arrows A2 and A4). In addition, the conductor 22 at the inner side is near the center 02. The opposed portions of the conductor 22 are therefore greatly affected by magnetic lines of force. As a result, the inductance L becomes small.

As the inductance L is reduced, the Q (quality factor) also becomes low. As a result, and as indicated by a dotted line T2 in FIG. 4, measured Q values are low at frequencies of 1.5 GHz to 4.0 GHz.

Since the conventional spiral inductor 23 is formed so that it has the same width over the entire inductor 23, the inner portions of the conductor 22 are near the center 02. The magnetic lines of force generated by this configuration greatly influence the opposed portions of the conductor 22, and hence reduce the inductance L. Accordingly, the Q is also reduced.

### SUMMARY OF THE INVENTION

Accordingly, it is an object of the present invention to provide a high Q spiral inductor with an increased inductance.

A spiral inductor device according to the present invention includes a planar insulating substrate and a spiral inductor formed of a conductor having a conductive pattern, the conductor being provided at least on a surface of the insulating substrate. The spacing between adjacent spiral turns of the conductor is the same, and the width of the conductor at the inner side is smaller than the width of the conductor at the outer side.

The width of the conductor forming the spiral inductor preferably becomes smaller step by step from the outer side to the inner side. The width of the conductor may also become smaller at each turn from the outer side to the inner side.

Alternatively, the width of the conductor forming the spiral inductor may gradually become smaller from the outer side to the inner side.

According to the present invention, the spacing between adjacent spiral turns of the conductor is the same over the entirety of the spiral inductor, and the width of an inner portion of the conductor is smaller than the width of an outer portion of the conductor. Thus, the inner portion of the conductor is spaced away from the center, and magnetic lines of force have a small effect on opposed portions of the conductor. This permits the inductance to become large. It is thus possible to provide a spiral inductor which has a higher Q as compared with that of a conventional spiral inductor.

Arranged as described above, the number of turns of the conductor can be increased. The spiral inductor can also be reduced in size, thereby increasing the inductance.

By reducing the width of the conductor forming the spiral inductor step by step from the outer side to the inner side, the design of the inductance can be simplified. Alternatively, the present invention is equally applicable to a polyangular spiral inductor by reducing the width of a polyangular spiral conductor at each corner thereof.

By reducing the width of the conductor forming the spiral inductor gradually from the outer side to the inner side, the width of the conductor can be reduced, and the number of turns of the conductor can be increased. As a result, the spiral inductor can be miniaturized, and the inductance can be increased.

### BRIEF DESCRIPTION OF THE DRAWINGS

FIG. 1 is a plan view of a spiral inductor according to an embodiment of the present invention;

FIG. 2 is a plan view of a conventional spiral inductor;

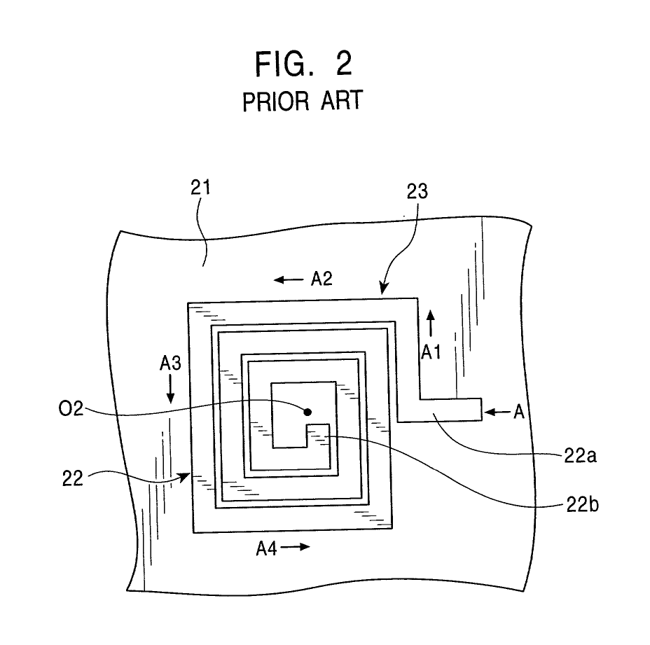

FIG. 3 is a graph showing measured inductance values for the spiral inductors; and

FIG. 4 is a graph showing measured Q values for the spiral inductors.

### DESCRIPTION OF THE PREFERRED EMBODIMENTS

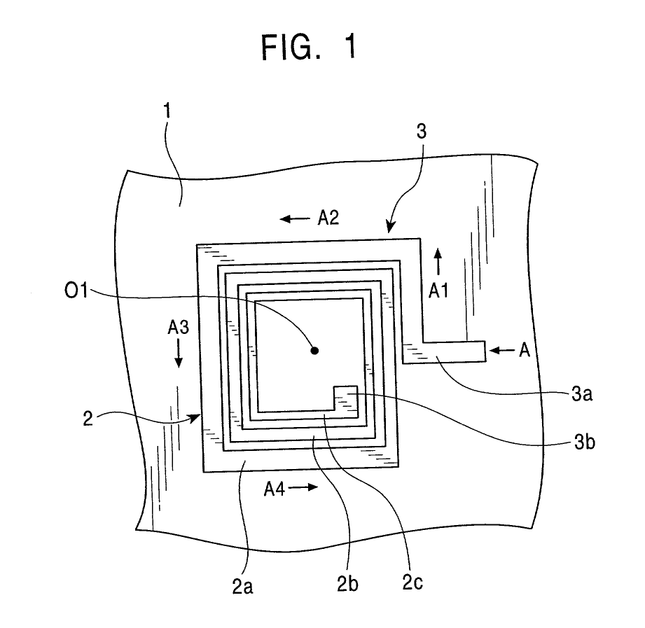

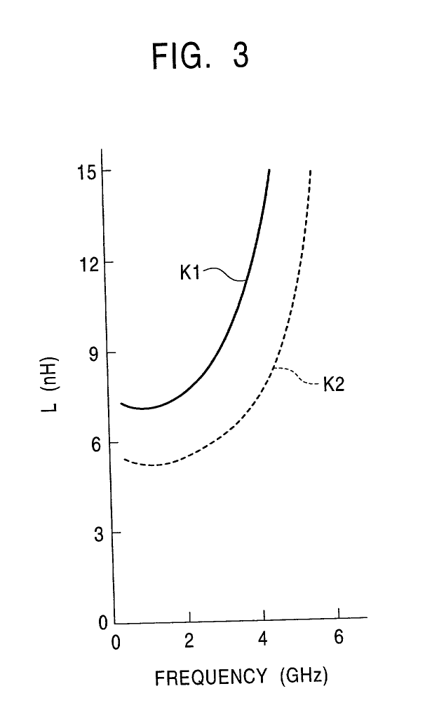

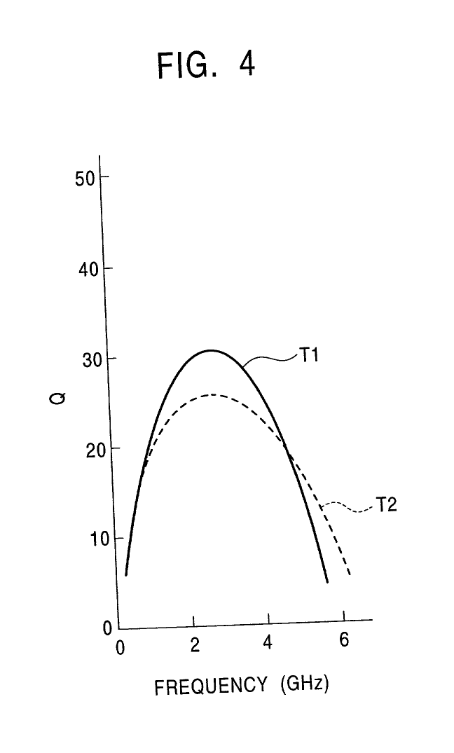

A spiral inductor according to the present invention will be described with reference to the following drawings: FIG. 1 is a plan view of a spiral inductor according to an embodiment of the present invention; FIG. 3 is a graph showing measured inductance values for the spiral inductor; and FIG. 4 is a graph showing measured Q values for the spiral inductor.

The structure of the spiral inductor according to the present invention is described in connection with FIG. 1. An insulating substrate 1 is formed from a printed wiring board or the like. A spiral inductor 3 comprising of a conductor 2 having a conductive pattern is fabricated on a surface of the insulating substrate 1. The width of an inner portion of the conductor 2 is smaller than the width of an outer portion of the conductor 2.

The inductor 3 is preferably formed by winding the conductor 2 using three turns. The width of a conductor 2a, i.e., the outermost first turn, is the largest. The width of a conductor 2b, i.e., the second turn, is smaller than that of the conductor 2a. The width of a conductor 2c, i.e., the third turn, is smaller than that of the conductor 2b.

More specifically, the width of the conductor 2 forming the spiral inductor 3 becomes smaller in step by step fashion from the outer portion to the inner portion. The spacing between adjacent spiral turns of the conductor 2 is preferably the same over the entire spiral inductor 3, i.e., from the outermost portion to the innermost portion.

A first end at the outer side of the inductor 2 and a second end at the inner side form terminal areas 3a and 3b, respectively. When an electrical current A flows from the terminal area 3a and is led out from the terminal area 3b, the current A flows in directions indicated by arrows A1, A2, A3, and A4.

With regard to the spiral inductor 3 shown in FIG. 1, the width of the conductor 2a is 75 μm, the width of the conductor 2b is 50 μm, and the width of the conductor 2c is 25 μm. The spiral conductor 3 is wound using three turns at a constant spacing of 25 μm between successive turns. Referring to FIG. 3, a solid line K1 indicates measured inductance values L (nH) for the inductor 3 according to the present invention. As is clear from FIG. 3, the inductance L of the spiral inductor 3 according to the present invention is large, i.e., 7.5 to 12 nH, at frequencies of 1.5 GHz to 4.0 GHz, as compared with the inductance L of 5 to 7 nH of the conventional spiral inductor.

A factor causing the large inductance L of the spiral inductor 3 is described as follows. Specifically, when the current A flows through the spiral inductor 3, the current A flows through opposed portions of the conductor 2, with respect to the center 1 of the inductor 3, at the opposite sides (the arrows A1 and A3, and the arrows A2 and A4). Since the inductor 3 is formed such that the width of the conductor 2 is smaller at the inner side, the conductor 2c at the inner side is spaced away from the center 01. Thus, the magnetic lines of force have a small effect on the opposed portions of the conductor 2, and the inductance L is increased.

As the inductance L becomes large, the Q also becomes high. As a result, as indicated by a solid line T1 in FIG. 4, the spiral inductor 3 of the present invention has higher measured Q values as compared with those for the conventional spiral inductor at frequencies of 1.5 GHz to 4.0 GHz.

Although the preferred embodiment of the present invention has been described using a quadrangular spiral inductor, a triangular spiral inductor, a polyangular (pentagonal), spiral inductor, or a circular spiral inductor can be alternatively used.

Although the preferred embodiment has been described as having a width of the conductor 2 that becomes smaller with every turn, the present invention is not limited to this embodiment. For example, when the present invention is applied to a polyangular spiral inductor, the width of the conductor 2 can be reduced at every angle or side. When a polyangular or a circular spiral inductor is used, the width of the conductor 2 can be gradually reduced.

what is claimed is:

1. A spiral inductor device comprising:
a planar insulating substrate; and
a spiral inductor formed of a conductor having a conductive pattern, said conductive pattern having a plurality of adjacent spiral turns, said conductor being provided on a surface of said insulating substrate;
wherein the spacing between adjacent spiral turns of the conductor is the same, and a width of the conductor at an inner side is smaller than a width of the conductor at an outer side.

2. A spiral inductor device according to claim 1, wherein the width of the conductor forming said spiral inductor becomes incrementally smaller from the outer side to the inner side.

3. A spiral inductor device according to claim 2, wherein the width of the conductor becomes smaller every turn from the outer side to the inner side.

4. A spiral inductor device according to claim 1, wherein the width of the conductor forming said spiral inductor becomes gradually smaller from the outer side to the inner side.
